(19) United States
(12) Patent Application Publication
(10) Pub. No.: US 2024/0304352 A1
(43) Pub. Date: Sep. 12, 2024

(54) System and Method For Fractional Elution of Mother-Daughter Radionuclides

(71) Applicant: Northstar Medical Technologies, LLC, Beloit, WI (US)

(72) Inventors: James T. HARVEY, Naperville, IL (US); Daniel DEVRIES, Madison, WI (US); Glenn H. ISENSEE, Minocqua, WI (US); Dorian LUST, Columbus, WI (US); Erik BLUEMNER, Verona, WI (US)

(73) Assignee: Northstar Medical Technologies, LLC, Beloit, WI (US)

(21) Appl. No.: 18/513,220

(22) Filed: Nov. 17, 2023

Related U.S. Application Data
(60) Provisional application No. 63/449,185, filed on Mar. 1, 2023.

(51) Int. Cl. G21G 1/00

(52) U.S. Cl. CPC G21G 1/001; G21G 2001/0021; G21G 2001/0042; G21G 2001/0073; G21G 2001/0089

(57) ABSTRACT

A method and a system for eluting a desired activity concentration of a daughter radionuclide-containing eluate obtained from a mixture of mother/daughter radionuclides is disclosed. The method comprises contacting separation particles with an aqueous solution containing a mixture of mother and daughter radionuclides wherein daughter radionuclides bind to separation particles and mother radionuclides does not. That contact is maintained for a time for unbound daughter radionuclide to bind to the separation particles. The unbound mother radionuclide is separated from the daughter radionuclide-bound separation particles using a washing solution. A first fractional amount of the bound daughter radionuclide is stripped from the separation particles using a volume of stripping solution so that an aqueous eluate solution having a desired daughter radionuclide activity is obtained. The remaining aqueous solution containing a second fractional amount of the desired daughter radionuclide still in the aqueous solution is retained.

### CROSS-REFERENCE TO RELATED APPLICATION

This application claims the benefit of the filing date of U.S. provisional application Ser. No. 63/449,185, filed Mar. 1, 2023, entitled, “System and Method for Fractional Elution of Mother-Daughter Radionuclides,” all of which is hereby incorporated by reference as if fully set forth herein.

### FIELD OF THE INVENTION

The present invention is generally related to the production and separation of radionuclides for medical purposes. More particularly, the invention contemplates a method of separating and eluting mother and desired daughter radionuclides that provides enhanced precision of desired daughter radionuclide activity in the collected desired daughter radionuclide eluate than if multiple separate elutions were to have been used. The contemplated invention can also provide an extended useful life of a radioactive source because it can utilize activity from a plurality of sources into the same liquid volume.

### BACKGROUND OF THE INVENTION

The therapeutic and diagnostic uses of radionuclides have recently grown to a point at which the need for the radionuclides has outgrown the ability to produce the required isotopes rapidly and cost-effectively. Patients and potential patients are therefore being left without an appropriate diagnosis or therapy.

Illustrative radionuclides in demand include rhenium-188 (Re188), a beta-emitter with a half-life of about 17 days, which is used for radiopharmaceuticals for diagnostic and therapy for malignant tumors, bone metastases, and rheumatoid arthritis. Gallium-68 (Ga68), with a half-life of about 68 minutes, emits positrons and is used in positron emission tomography (PET) scans. Some PET/CT combination scanners also run a CT (computed tomography) scan in the same session and then merge the images together. Technetium-99m (Tc99m), whose half-life is about 6 hours, is used in tens of millions of medical diagnostic procedures annually in oncology, neurology, and cardiology, making it the most commonly used medical radioisotope in the world. Actinium-225 (Ac225), primarily used in cancer therapy and having a half-life of about 10 days, is an alpha emitter, releasing four alpha particles per initially present Ac225 atom, and is used medically in targeted alpha therapy (TAT) for the treatment of prostate, brain, and neuroendocrine cancers. Bismuth-213 (Bi213) is a candidate alpha emitter proposed for use in cancer therapy.

Each of the above-named isotopes is the product of the radioactive decay of a parental isotope referred to herein as a mother isotope, with the enumerated decay-product isotope being referred to as a daughter isotope. Thus, Re188 is the daughter of the mother isotope tungsten-188 (W188), Ga68 is the daughter of germanium-68 (Ge68), Tc99m is the daughter of molybdenum-99 (Mo99), the mother of Ac225 is radium-225 (Ra225), and Bi213 is the daughter of Ac225

It is to be understood that except for uranium, each of the mother isotopes is a daughter of a higher atomic weight mother isotope. However, as used herein, the isotope used as the immediately prior starting material is the named mother, and desired product isotope is referred to as the daughter isotope. Thus, for example, Tc99m is the daughter of molybdenum-99 (Mo99). Both can be present in the same solution at the same time and can be separated from each other prior to medical use of Tc99m.

In one exemplary decay pattern, Bi213 can be obtained from thorium-229 (Th229) containing trace contaminates of thorium-228 (Th228) by selectively isolating Ac225. In a more complex decay pattern, radium-226, the longest-lived form of radium, can be bombarded with neutrons to form radium-225 (Ra225), whose half-life is about 15 days, then produces Ac225 as a daughter. To obtain the Ac225 in usable form, it must be separated from both the Ra226 that was not converted and can be present, and Ra225 that had not decayed, as well as possible decay products from the Ac225. In this circumstance, Ac225, the desired material for use, is the daughter radionuclide, and Ra225, the immediate prior starting material, is referred to as the mother isotope. Ra225 can also be referred to as a step-daughter of Ra226, as it is a transmutation product rather than a natural decay product. Ra225 is also the mother of Ac225. However, where Ra226 is the starting material, and Ac225 is the desired product, they are referred to as mother and step-granddaughter, respectively.

Because most of the medically useful radionuclides are produced by means of a human-induced bombardment of a parental isotope via a physically large and expensive high-energy nuclear device such as a cyclotron, synchrotron, an electron beam or similar device that is not generally at or near to a medical treatment or diagnostic center, the synthetically-produced mother, daughter or other parent radionuclide must be transported. Such transportation by vessel, rail, public highway and/or air is typically under the jurisdiction of a governmental agency and its rules.

In the United States, those transportation rules are set out in 49 CFR Subtitle B, Chapter 1, subchapter C.

In sum, the transportation regulations get significantly more prohibitive when there is more than 19 Ci of activity for a shipment such as Mo99/Tc99. An effect of those regulations is to limit the total radioactivity of the transported radionuclides, which can cause the receiving medical facility to utilize isotopic concentrations at lower concentrations than might otherwise be desirable.

Another limiting factor with activity at the site of use is that the sources (mothers and daughters) decay over time. Illustratively, because of the complexity of manufacturing Mo99 sources for the formation of Tc99m, new sources of Mo99 are not available every day.

In the separation methods primarily contemplated here, the solution of parent radionuclide is eluted through a chromatographic column specific for the desired daughter radionuclide (primary separation column, PSC). The daughter nuclide is retained on the PSC, while the parent passes through unretained. A small volume of rinse solution is then typically passed through the PSC to ensure near complete recovery of the parent nuclide. The solution of parent nuclide is then stored for ingrowth of the desired daughter and future processing. The daughter nuclide is stripped from the PSC, and this strip solution is often passed through a second column (guard column), which is specific for the parent nuclide. The guard column provides additional decontamination of the parent radionuclide from the daughter product. See, McAlister and Horwitz, “Automated two column generator systems for medical radionuclides”, Applied Radiation and Isotopes 67: 1985-1991 (2009).

An inexpensive, rapid means for enhancing the amount of desired radioactivity available to a medical professional in a safe, shielded environment is therefore needed. The invention below is believed to provide one solution to the need for enhanced, inexpensive, and rapidly useful enhancement of useful radioactivity obtained from a rule-abiding transportable radioactivity source. Further fractional elution can be useful in nuclear pharmacies between production runs because by only capturing and eluting a portion of the source material, the remaining eluent can be retained for subsequent runs. Moreover, depending on the mother radionuclide and desired radionuclide and/or the application of the product, various activity concentrations and activities levels can be needed. Thus, there is a need for a method and system that can produce a range of daughter radionuclide activity concentrations and/or activity levels in an efficiency manner.

### BRIEF SUMMARY OF THE INVENTION

In a first aspect, the present invention contemplates a method and system for enhancing the efficiency of elution and providing a broader range of activity concentration and activity levels of a desired daughter radionuclide in an eluted composition from a separation column that binds a daughter radionuclide and does not bind the mother radionuclide under one elution condition and releases the daughter radionuclide when eluted under a different elution condition. This type of elution is referred to herein as “fractional elution” or “partial elution.” Here, the improvement lies in only capturing and eluting a fractional amount of the desired daughter radionuclide.

Thus, the source material solution still contains a fractional amount of the desired daughter radionuclide. Eluting only a fraction of the source material solution allows the activity in the non-eluted portion of the source material solution to be saved for further elutions, which can increase the efficiency of subsequent elutions. Moreover, it is found that by using fractional elution, a range of daughter radionuclide activity concentrations and activity levels can be achieved by adjusting the fraction of the source material eluted.

Thus, in a first aspect, the method comprises the steps of: contacting separation particles with an aqueous source material solution, wherein the source material solution is a mixture of a mother radionuclide and a desired daughter radionuclide, and wherein the desired daughter radionuclide binds to the separation particles and the mother radionuclide does not bind to the separation particles to form a dispersion containing at least water, the separation particles, the desired daughter radionuclide, the separation particles bound to the desired daughter radionuclide, and a unbound mother radionuclide; maintaining that contact for a time period sufficient for an unbound desired daughter radionuclide to bind to the separation particles; separating the unbound mother radionuclide from the desired daughter radionuclide bound separation particles using a washing solution; stripping a first fractional amount of the bound desired daughter radionuclide from the separation particles using a volume of stripping solution to form an aqueous eluate solution having a desired daughter radionuclide activity; and retaining a second fractional amount of the desired daughter radionuclide in the aqueous solution.

In a second aspect, the desired daughter radionuclide is Tc99m present as
TcO₄⁻¹ or Re188 present as ReO₄⁻¹.

In a third aspect, the separation particles comprise particles having a plurality of covalently bonded —X—(CH₂CH₂O)ₙ—CH₂CH₂R groups, wherein X is O, S, NH or N—(CH₂CH₂O)ₘ—R³, where m is a number having an average value of zero to about 225, n is a number having an average value of about 15 to about 225, R³ is hydrogen, C₁-C₂ alkyl, 2-hydroxyethyl or CH₂CH₂R, and R is selected from the group consisting of —OH, C₁-C₁₀ hydrocarbyl ether having a molecular weight up to about one-tenth that of the —(CH₂CH₂O)ₙ-portion, carboxylate, sulfonate, phosphonate and —NR¹R² groups where each of R¹ and R² is independently hydrogen, C₂-C₃ hydroxyalkyl or C₁-C₆ alkyl, or —NR¹R² together form a 5- or 6-membered cyclic amine having zero or one oxygen atom or zero or one additional nitrogen atom in the ring, the separation particles having a percent CH₂O/mm² of particle surface area of greater than about 8000 and less than about 1,000,000.

In a fourth aspect, the mother radionuclide for the desired daughter radionuclide Tc99m is present as MoO₄⁻².

In a fifth aspect, the mother radionuclide for the desired daughter radionuclide Re188 is present as WO₄⁻².

In a sixth aspect, the desired daughter radionuclide is Ac225 present as Ac⁺³.

In a seventh aspect, the mother radionuclide for the desired daughter radionuclide Ac225 is present as Ra⁺².

In an eighth aspect, the Ra⁺² is one or both of Ra225 and Ra226.

In a ninth aspect, the separation particles comprise a diglycolamide extractant corresponding in structure to Formula I:

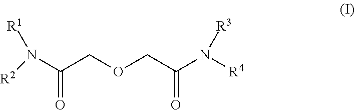

dispersed onto a porous resin or silica support, and wherein R¹, R², R³ and R⁴ are the same or different and are hydrido or hydrocarbyl groups such that the sum of carbon atoms of R¹+R²+R³+R⁴ is about 14 to about 56.

In a tenth aspect, the desired daughter radionuclide is Ga68 present as Ga⁺⁴.

In an eleventh aspect, the mother radionuclide for the desired daughter radionuclide Ga⁺⁴ is present as Ge⁺⁴.

In a twelfth aspect, the separation particles comprise a strongly basic anion exchange resin with quaternary ammonium functional groups attached to the styrene divinylbenzene copolymer lattice cross-linked with about 2 to about 12 wt % of divinylbenzene.

In a thirteenth aspect, the desired daughter radionuclide is Bi213 present as Bi⁺³.

In a fourteenth aspect, the mother radionuclide for the desired daughter radionuclide is Ac225 present as Ac⁺³.

In a fifteenth aspect, an elution system for eluting a desired activity concentration of a radionuclide activity of a desired daughter radionuclide-containing eluate is provided. The elution system comprises: a first inlet for a conditioning fluid; a second inlet for a stripping fluid; a fluid movement system in fluid communication with the first inlet and the second inlet; a primary separation cartridge (PSC) bay in fluid communication with the fluid movement system; a source container, which could also be named a source farm, in fluid communication with the fluid movement system; a recycling accumulator in fluid communication with the fluid movement system; and a product bay in fluid communication with the fluid movement system.

In a sixteenth aspect, the fluid movement system comprises: an inlet manifold comprising an inlet valve configured to direct a direction of fluid flow through the inlet manifold; a pump manifold downstream and in fluid communication with the inlet manifold, wherein the pump manifold comprises a pump valve configured to direct a direction of fluid flow through the pump manifold; a pump downstream of the inlet manifold and in fluid communication with the pump manifold; a PSC manifold downstream and in fluid communication with the pump manifold, wherein the PSC manifold comprising a PSC valve configured to direct a direction of fluid flow through the PSC manifold; and an outlet manifold downstream and in fluid communication with the PSC manifold, wherein the outlet manifold comprises an outlet valve configured to direct a direction of fluid flow through the outlet manifold.

In a seventeen aspect, the PSC bay comprises one or more separation columns.

In an eighteenth aspect, the source container comprises one or more source containers and one or more transfer containers.

In a nineteenth aspect, the recycling accumulator comprises one or more recycling containers designed to collect one or more fluids passed through the elution system.

In a twentieth aspect, the product bay comprises a product container.

In a twenty-first aspect, the product bay comprises a guard column upstream of the product container.

In a twenty-second aspect, the elution system comprises a stripping solution pump downstream and in fluid communication with the second inlet and upstream of the fluid movement system.

In a twenty-third aspect, a method for enhancing the radionuclide activity of a desired daughter radionuclide-containing aqueous eluate separated from an aqueous composition containing a mother radionuclide and a daughter radionuclide in which said aqueous composition is 1) contacted with a separation medium in which said desired daughter radionuclide has a high affinity for and binds to said separation medium and said mother radionuclide has a low affinity for and does not bind to said separation medium to form a dispersion containing at least water, separation medium, desired daughter radionuclide, separation medium-bound to said desired daughter radionuclide, and unbound mother radionuclide 2) that contact is maintained for a time period sufficient for unbound desired daughter radionuclide to bind to the separation medium, 3) the unbound mother radionuclide is separated from the desired daughter radionuclide-bound separation medium formed in step 2) using a washing solution, and 4) the bound desired daughter radionuclide is stripped from the separation medium using a volume of stripping solution to form an aqueous eluate; wherein the improvement comprises stripping a first fractional amount of the bound desired daughter radionuclide from the separation particles using a volume of stripping solution to form the aqueous eluate solution having a desired daughter radionuclide activity, such that a second fractional amount of the desired daughter radionuclide is retained in the separation particles, thereby enhancing the desired daughter radionuclide activity in subsequent elutions than if a fractional amount of the desired daughter radionuclide was not retained in the separation particles.

In a twenty-fourth aspect, the desired daughter radionuclide is Tc99m present as TcO₄⁻¹ or Re188 present as ReO₄⁻¹.

In a twenty-fifth aspect, the mother radionuclide for the desired daughter radionuclide Tc99m is present as Mo₄⁻².

In a twenty-sixth aspect, the mother radionuclide for the desired daughter radionuclide Re188 is present as WO₄⁻².

In a twenty-seventh aspect, the mother radionuclide for the desired daughter radionuclide Re186 is present at W186.

In a twenty-seventh aspect, the desired daughter radionuclide is Ac225 present as Ac⁺³.

In a twenty-eighth aspect, the mother radionuclide for the desired daughter radionuclide Ac225 is present as Ra⁺².

In a twenty-ninth aspect, the Ra⁺² is one or both of Ra225 and Ra226.

In a thirtieth aspect, the desired daughter radionuclide is Ga68 present as Ga⁺⁴.

In a thirty-first aspect, the mother radionuclide for the desired daughter radionuclide Ga⁺⁴ is present as Ge⁺⁴.

The present invention thus contemplates an improved method for capturing and eluting a fractional amount of a desired daughter radionuclide in an eluted composition from a column of separation particles that bind a daughter radionuclide and does not bind the mother radionuclide under one loading condition and releases the daughter radionuclide when eluted under a different elution condition and a system for such elution.

A benefit of fractional elution is that a broader range of daughter radionuclide activity concentrations and activity levels can be achieved by adjusting the fraction of the source material eluted. Thus, a user can more precisely obtain a desired activity concentration and/or level of the daughter radionuclide.

Moreover, because only a fraction or portion of the source material is eluted, a fraction of the daughter radionuclide can be retained in the source material. A benefit of retaining a fraction of the daughter radionuclide is that a user can obtain greater amounts of the daughter radionuclide from subsequent elutions. Thus, fractional elution can provide a more accurate and efficient method of elution.

As used herein, the term “hydrocarbyl” is a short-hand term for a non-aromatic group that includes straight and branched chain aliphatic as well as alicyclic groups or radicals that contain only carbon and hydrogen. Inasmuch as alicyclic groups are cyclic aliphatic groups, such substituents are deemed hereinafter to be subsumed within the aliphatic groups. Thus, alkyl, alkenyl and alkynyl groups are contemplated, whereas aromatic hydrocarbons such as phenyl and naphthyl groups, which strictly speaking are also hydrocarbyl groups, are referred to herein as aryl groups, substituents, moieties or radicals, as discussed hereinafter.

### BRIEF DESCRIPTION OF THE DRAWINGS

FIG. 1 illustrates an exemplary embodiment of a system for fluid flow and for elution with a first conditioning step in a fractional elution method;

FIG. 2 illustrates an exemplary embodiment of the elution system with a second loading step in a fractional elution method;

FIG. 3 illustrates an exemplary embodiment of the elution system with a third loading step in a fractional elution method;

FIG. 4 illustrates an exemplary embodiment of the elution system with a fourth washing step in a fractional elution method;

FIG. 5 illustrates an exemplary embodiment of the elution system with a fifth pH adjustment step in a fractional elution method;

FIG. 6 illustrates an exemplary embodiment of the elution system with a sixth collection step in a fractional elution method; and

FIG. 7 illustrates an exemplary embodiment of the elution system with a seventh conditioning step in a fractional elution method.

### DETAILED DESCRIPTION

Although this invention is susceptible of embodiments in many different forms, specific embodiments are shown in the drawings and described in detail herein with the understanding that the present disclosure is an exemplification of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. The use of the article “a” or “an” is intended to include one or more.

The present invention contemplates a method for improving elution efficiency and providing a broader range of activity concentration and activity levels of a desired daughter radionuclide-containing eluate obtained from a solution containing a mixture of mother radionuclide and desired daughter radionuclide, possibly other radionuclides and a system for such elutions. Elution generally comprises the steps of contacting separation particles with an aqueous solution containing a mixture of the mother radionuclide and desired daughter radionuclide.

The desired daughter radionuclide ions (such as atomic ions like Bi⁺³, Ac⁺³ or Ra⁺², or complex ions containing them such as TcO₄⁻¹ and ReO₄⁻¹) have a high affinity for (bind or otherwise adhere to) the separation medium and the mother radionuclide has a low affinity for (does not bind to) the separation medium to form a dispersion containing at least water, separation medium, desired daughter radionuclide, separation medium-bound to the desired daughter radionuclide, and unbound mother radionuclide. That contact is maintained for a time period sufficient for the unbound desired daughter radionuclide to bind to the separation particles (loading the separation medium). This time period is usually relatively short, taking about 1 to about 30 minutes, in that the mother isotope does not bind to the separation particles, and the daughter isotope does bind.

The unbound mother radionuclide is separated from the desired daughter radionuclide-bound separation particles formed in the previous step using a washing solution. The separation medium loading can be repeated at least once and up to the binding limit of the desired daughter radionuclide to the separation particles used. The bound desired daughter radionuclide is then stripped from the separation particles using a volume of stripping solution to form an aqueous eluate solution having enhanced desired daughter radionuclide activity.

Broadly speaking, the mother isotope and possible other non-desired materials typically passed through the separation medium, whereas the desired daughter isotope binds to the column. The relative affinities of the mother and daughter isotope-containing ions for the separation medium is usually measured as a decontamination factor (DF) that can be obtained from ratios of the dry weight distribution ratios (D_{W}) for an analyte and impurity. A D_{W} value of less than 20 generally means little if any retention of the ion of the separation medium.

An individual separation medium in a column utilized provides a decontamination factor (DF) of the desired daughter from the mother (parent) radionuclide impurities likely to be present is about 10¹ or greater (more) under the conditions of contacting. A typical DF value is more usually about 10² to about 10⁵ or greater, under the conditions of contacting. A DF value of about 10¹⁰ is about the largest DF that can be readily determined using typical radioanalytical laboratory apparatus. A decontamination factor, its definition and calculation are discussed in U.S. Pat. Nos. 5,603,834 and 6,852,296 to Bond et al., at column 20, line 55 through column 21, line 26, as well as in several of the other patents and publications noted herein.

Using DF values as criteria, the difference between high and low affinities of the separation medium between mother and daughter radionuclide ions provides a DF value of about 101 or greater, and preferably about 102 to about 105 or greater, up to about 1010. The DF value for the mother is about zero to about 1. Looked at differently, the mother radionuclide exhibits a Dw value of less than about 20 when used with the contemplated separation medium.

Although the above-described method is believed general, different mother and daughter radionuclides can require different separation particles and solutions for loading, washing and stripping the bound, desired daughter radionuclide from the separation particles. Illustrative mother and daughter radionuclide pairs include W188 and Re188, Ge68 and Ga68, Mo99 and Tc99m, Th229 and Ac225, Ra225 and Ac225, Ac225 and Bi213, Th227 and Ac227 and Ra223, Ra224 and Pb212, Th228 and Ra224, and Sr82 and Rb82, respectively. It is noted that Ra226 is also the grandmother of Ra225, with the latter being the direct mother of Ac225.

A contemplated method and system can utilize one or more separation media. The separation medium or media utilized for a given separation is governed by the radionuclides to be separated, as is well-known. The particles can be quite varied in make-up and are inert to (are unreactive to the media, solutions and temperatures used in the separations) and are insoluble in the separation/recovery aqueous environment that can be very acidic or basic.

Preferred separation media are typically bead-shaped (generally spherical) of consistent size and morphology solid phase resins usually present as particles, although sheets, webs, or fibers of separation medium can be used. In a preferred method that utilizes separation medium beads, the support beads that comprise the separation medium are packed into a column. When a solution is passed through the beads, the solution can flow over, through and around the beads, coming into intimate contact with the separation medium. Separation particles having smaller particle diameters, e.g., 200-400 mesh (80-5 microns), are favored over particles having larger diameters, e.g., 80-120 mesh (180-115 microns), because of the greater surface area per gram provided by the smaller particles. In addition, porous materials having smaller pore sizes are preferred. Illustrative separation particles are discussed in the U.S. patents cited hereinafter.

A contemplated separation medium is typically an item of commerce that is comprised of solid or porous particles or resins that contain chelating or other binding groups that provide affinity for and with which the daughter isotopes interact and adhere, and with which the mother isotopes do not adhere as tightly or at all, thereby exhibiting a lower affinity. The mechanisms through which, and separation results obtained using, such media are sufficiently understood in the art to provide commercial utility to these materials.

Thus, using the discussed separation media as suggested by their manufacturers' literature typically provides isotopic separations that are sufficient to pass governmental criteria to enable use of the ultimately separated daughter isotope to be used medicinally for humans. Illustrative data for the differences in binding and elution of mother and daughter isotopes can be seen in the disclosures of U.S. Pat. Nos. 5,707,525, 5,603,834, 5,888,397, 6,852,296, 7,157,022, 7,553,461, as well as the publications cited therein and those cited herein.

One separation medium comprises particles having a diglycolamide (DGA) extractant dispersed onto an inert, porous support such as polymeric resin or silica particles. Such a contemplated separation medium can separate a preselected multivalent metal cation such as a pseudo-lanthanide [e.g., scandium (III) and yttrium (III)], a prelanthanide [lanthanum (III)], a lanthanide, a preactinide [actinium (III)] or an actinide cation, like trivalent americium (Am⁺³), yttrium (Y⁺³) and ytterbium (Yb³⁺) cations from other cations such as radium (Ra⁺²) cations present in an acidic aqueous solution. A contemplated preselected multivalent metal cation, other than cadmium, typically has a crystal ionic radius in Ångstrom units of about 0.8 to about 1.2.

Illustrative processes for separating Ac225 from radium ions such as those of Ra225 and Ra226 are illustrated in U.S. Pat. Nos. 7,157,022 and 7,553,461 to Horwitz et al. that describe and claim separation particles that comprise a diglycolamide extractant corresponding in structure to Formula I, below,

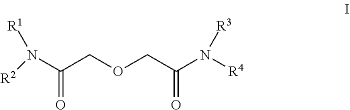

dispersed onto a porous inert resin or silica support, wherein R¹, R², R³ and R⁴ are the same or different and are hydrido or hydrocarbyl groups such that the sum of carbon atoms of R¹+R²+R³+R⁴ is about 14 to about 56.

These resins are available from Eichrom Technologies, Inc., under the broad title of “DGA Resins”. Two DGA resins are available in which R¹, R², R³ and R⁴ are the same within a particular molecule. One as N, N, N′,N′-tetra-n-octyl-diglycolamide (DGA Resin, Normal) and the other as N, N, N′,N′-tetra-2-ethylhexyldiglycolamide (DGA Resin, Branched; and sometimes as TEHDGA resin).

Exemplary preferred particles are the particularly preferred reacted cross-linked poly(styrene-vinyl benzyl halide) resins, often called Merrifield's peptide resin or chloromethylated divinylbenzene cross-linked polystyrene, as well as glass or silica gel (silica-based) materials, cross-linked poly(ethylene glycol)-containing urethane or urea resins, cross-linked dextran- and agarose-based materials, and also various cross-linked acrylate esters. It is noted that the separation particles can contain some reactive functionality, such as benzyl halide groups that can react in the aqueous biphase-forming environment.

Illustrative separation particles for the Mo99/Tc99m and W188/Re188 pairs are discussed in U.S. Pat. Nos. 5,603,834, and 5,888,397 to Rogers et al. Those patents disclose and claim the use of separation particles that can be quite varied in make-up, and are inert to and insoluble in the separation/recovery aqueous salt biphase-forming environment that can be very acidic or basic.

Exemplary preferred particles are the particularly preferred reacted cross-linked poly(styrene-vinyl benzyl halide) resins often called Merrifield's peptide resin or chloromethylated divinylbenzene cross-linked polystyrene, as well as glass or silica gel (silica-based) materials, cross-linked poly(ethylene glycol)-containing urethane or urea resins, cross-linked dextran- and agarose-based materials, and also various cross-linked acrylate esters. It is noted that the separation particles can contain some reactive functionality such as benzyl halide groups that can react in the aqueous biphase-forming environment.

These separation particles contain a plurality of covalently bonded

—X—(CH₂CH₂O)ₙ—CH₂CH₂R groups, wherein X is O, S, NH, or N—(CH₂CH₂O)ₘ—R³, where m is a number having an average value of zero to about 225, n is a number having an average value of about 15 to about 225. R³ is hydrogen, C₁-C₂ alkyl, 2-hydroxyethyl or CH₂CH₂R, and R is selected from the group consisting of —OH, C₁-C₁₀ hydrocarbyl ether having a molecular weight up to about one-tenth that of the (CH₂CH₂O)ₙ-portion, carboxylate, sulfonate, phosphonate and —NR¹R² groups where each of R¹ and R² is independently hydrogen, C₂-C₃ hydroxyalkyl or C₁-C₆ alkyl, or —NR¹R² together form a 5- or 6-membered cyclic amine having zero or one oxygen atom or zero or one additional nitrogen atom in the ring. These separation particles have a percent CH₂O/mm² of particle surface area of greater than about 8,000 and less than about 1,000,000.

Particularly preferred separation particles (medium) of this group are available from Eichrom Technologies, Inc., located at 1955 University Ln, Lisle, IL 60532, USA, under the name ABEC®. These materials and their properties are discussed in Gula and Harvey, “Separation, Concentration, and Immobilization of Technetium and Iodine from Alkaline Supernate Waste,” Final Report, Mar. 11, 1998, DE-AC21-97MC33137-43. ABEC® resins and separations using them are also discussed in Bond et al., Ind Eng Chem Res 38 (4): 1676-1682 (1999) and in Bond et al., Ind Eng Chem Res 38 (4): 1683-1689 (1999).

Exemplary chaotropic anions include simple anions such as Br⁻¹ and I⁻¹ and polyatomic anions such as TcO₄⁻¹, ReO₄⁻¹, or IO₃⁻¹. The chaotropic anion can also be a complex of a metal cation and halide or pseudohalide anions. A particularly useful separation that can be affected using this separation medium is that of 99m TcO₄⁻¹ from an aqueous solution that also contains the parent radionuclide 99MoO₄⁻² ions. Further details concerning the ABEC® separation medium and its uses can be found in U.S. Pat. Nos. 5,603,834, 5,707,525, and 5,888,397.

Another separation of rhenium from tungsten is carried out by the capture of tungstic acid on alumina, followed by drying for shipment and stripping using aqueous saline. See, Argyrou et al., Int J Mol Imaging 2013, Article ID 290750, 7 pages.

Illustrative processes for separating Ac225 from Th229 are described in U.S. Pat. No. 7,087,206 to Bond et al. disclose the purification of actinium (III) cations such as Ac225 using a multicolumn selectivity inversion generator where Ac225 and its immediate radiogenic parent radium (II) cations such as Ra225 are efficiently removed from solutions containing thorium (IV) cations such as Th229 and the radioisotopic impurity Th228 preferably through the use of a first separation medium that preferably comprises a strong acid, sulfonate-containing polymeric extractant such as a cation-exchange resin as is discussed hereinafter.

The aqueous, preferably acidic, sulfate solution of radioactive parent and daughters is preferably at about radioactive steady state as ions in solution prior to contacting the first separation medium. Exemplary anion-exchange resins include Bio-Rad® AG®MP-50 macroporous sulfonic acid cation-exchange resin, Bio-Rad® 50W-X8 cation exchange resin can be provided in the H+ form, which are commercially available from Bio-Rad Laboratories, Inc., of Hercules, CA, Amberlite® IRA-900, IRA-904 and IRA-402 resins as well as the Dowex® 1X2-100, 1X2-400, and 1X4-200 resins that are available commercially from Sigma Chemical Co., St. Louis, MO.

Illustrative processes for separating Ac225 from radium ions, such as those of Ra225 and Ra226, are illustrated in U.S. Pat. Nos. 7,157,022 and 7,553,461 to Horwitz et al. that describe and claim separation particles that comprise a diglycolamide extractant corresponding in structure to Formula I:

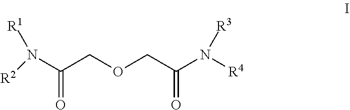

The separation particles can be dispersed onto a porous inert resin or silica support, wherein R¹, R², R³, and R⁴ are the same or different and are hydrido or hydrocarbyl groups such that the sum of carbon atoms of R¹+R²+R³+R⁴ is about 14 to about 56.

These resins are available from Eichrom Technologies, Inc., under the broad title of “DGA Resins.” Two DGA resins are available in which R¹, R², R³, and R⁴ are the same within a particular molecule. One as N, N, N′, N′-tetra-n-octyl-diglycolamide (DGA Resin, Normal) and the other as N, N, N′,N′-tetra-2-ethylhexyldiglycolamide (DGA Resin, Branched).

According to U.S. Pat. No. 7,728,310 to Fitzimmons et al., aqueous gallium-68 as Ga+⁴Cl₄ can be separated from germainium-68 as Ge⁺⁴Cl₄ using an anionic exchange resin such as Bio-Rad AG® 1-X₈, analytical grade, 100-200 mesh chloride form. Bio-Rad AG® 1-X₈ is said to be a styrene divinylbenzene copolymer lattice with quaternary ammonium functional groups attached. AG® 1-X₈ anionic exchange resin contains about 8% by weight cross-linking (X8), and similar resins having 2, 4, 10, and 12 weight percent cross-linking are available in several mesh sizes from Bio-Rad Laboratories, Inc., Hercules, CA, USA.

Illustrative processes for separating Bi213 from radioactive parental ions, such as Ac225 and Ra225, are illustrated in U.S. Pat. No. 6,852,296 to Bond et al. that describes and claims the purification of Bi213 by a multicolumn selectively inversion generator. Bond discloses extracting Bi213 from a radionuclide mixture by binding the Bi213 in a primary separation column comprising a particulate material such as a polymer that is coated with a phosphoryl group-containing extractant, that extractant is also water-insoluble. Particularly preferred separation particles of this group are available from Eichrom Technologies, Inc., of Lisle, IL, USA, under the name UTEVA®.

The Primary separation column is loaded and rinsed with 0.10 M HCl, and stripped with a solution of 0.75 M NaCl in 0.50 M (Na⁺, H⁺) OAc at pH=4.0 and 25(±2° C.) Eluate from the primary separation column is directed without chemical adjustment through a guard column. This guard column retains any potential long-lived Ra225/224 or Ac225 contaminants to ensure the high radionuclidic purity of the Bi213 product.

In a preferred embodiment, the guard column contains Bio-Rad® AGMP-50 macroporous sulfonic acid cation-exchange resin. Bio-Rad® 50W-X8 cation exchange resin can be provided in the H⁺ form, which is commercially available from Bio-Rad Laboratories, Inc., of Hercules, CA. Other useful strong acid cation-exchange media include the Bio-Rad® AGMP-50 and Dowex® 50W series of ion-exchange resins and the Amberlite® IR series of ion-exchange resins that are available from Sigma Chemical Co., St. Louis, MO. Anion-exchange resins such as the Bio-Rad® AGMP-1 and Dowex® 1 series of anion-exchange resins can also serve as separation medium particles.

Another particularly useful separation medium that is described in U.S. Pat. No. 5,110,474 to Horowitz et al., is referred to as “Sr Resin” and is available from Eichrom Technologies, Inc. Briefly, the Sr Resin comprises an inert resin substrate upon which is dispersed a solution of a crown ether extractant dissolved in a liquid diluent.

The liquid diluent is an organic compound that has: (i) a high boiling point, that is, about 170° C. to about 200° C. at one atmosphere, (ii) limited or no solubility in water, (iii) is a material in which the crown ether is soluble. These diluents include alcohols, ketones, carboxylic acids, and esters. Suitable alcohols include 1-octanol, which is most preferred, although 1-heptanol and 1-decanol are also satisfactory. The carboxylic acids include octanoic acid, which is preferred, in addition to heptanoic and hexanoic acids. Exemplary ketones include 2-hexanone and 4-methyl-2-pentanone, whereas esters include butyl acetate and pentyl acetate. These resins are discussed more fully in U.S. Pat. Nos. 5,110,474, and 6,511,630 to Horowitz and Dietz, respectively.

The macrocyclic polyether can be any of the dicyclohexano crown ethers, such as dicyclohexano-18-Crown-6, dicyclohexano 21-Crown-7, or dicyclohexano-24-Crown-8. The preferred crown ethers have the formula: 4,4′ (5′)-[(R, R′)dicyclohexano]-18-Crown-6, where R and R′ are one or more members selected from the group consisting of H and straight chain or branched alkyls containing 1 to 12 carbons. Examples include methyl, propyl, isobutyl, t-butyl, hexyl, and heptyl. The preferred ethers include dicyclohexano-18-crown-6 (DCH₁₈C₆) and bis-methylcyclohexano-18-Crown-6 (DMeCH₁₈C₆). The most preferred ether is bis-4,4′ (5′)-[(di-t-butyl)cyclohexano]-18-Crown-6 (Dt-BuCH₁₈C₆).

The amount of crown ether in the diluent can vary depending upon the particular form of the crown ether. For example, a concentration of about 0.1 to about 0.5 M of the most preferred t-butyl form (Dt-BuCH₁₈C₆) in the diluent is satisfactory, with about 0.2 M being the most preferred. When the hydrogen form is used, the concentration can vary from about 0.25 to about 0.5 M.

The preferred Sr Resin utilizes an inert resin substrate that is a nonionic acrylic ester polymer bead resin such as Amberlite® XAD-7 (60 percent to 70 percent by weight) having a coating layer thereon of a crown ether such as Dt-BuCH₁₈C₆ (20 percent to 25 weight percent) dissolved in n-octanol (5 percent to 20 weight percent), having an extractant loading of 40 weight percent. [See, Horwitz et al., Solvent Extr. Ion Exch; 10(2): 313-316 (1992).]

It has also been observed that Pb Resin, a related resin, also available from Eichrom Technologies, Inc. is also useful for purifying and accumulating Pb212 for the production of Bi212. Pb Resin has similar properties to Sr Resin except that a higher molecular weight alcohol, that is, isodecyl alcohol, is used in the manufacture of Pb Resin. [See, Horwitz et al., Anal. Chim. Acta, 292:263-273 (1994).] It has been observed that Pb Resin permits subsequent stripping of the 212Bi from the resin, whereas it has been observed that Pb212 is strongly retained by the Sr Resin.

An improved Sr Resin, also available from Eichrom Technologies, Inc., is even more selective. This separation medium is referred to as Super Pb(Sr)™ selective resin and comprises free-flowing particles having about 5 to about 50 weight percent of a bis-4,4′ (5′) [C₃-C₈-alkylcyclohexano] 18-Crown-6, such as Dt-BuCH₁₈C₆, that exhibits a partition ratio between n-octanol and 1 M nitric acid (DCrown=[CrownOrg]/[Crown]Aq) of greater than about 103, and usually of about 103 to about 106, dispersed onto an inert, porous support such as a polymeric resin (e.g., Amberchrom®-CG71) or silica particles. The separation medium is free of a diluent, and particularly free of a diluent that is: (i) insoluble or has limited (sparing) solubility in water and (ii) capable of dissolving a substantial quantity of water that is present in the Sr Resin. See U.S. Pat. No. 6,511,603.

Preferred wash and strip solutions that are used are also selected based upon the parent and daughter radionuclides and the desired use of the product. The reader is directed to Horwitz et al. U.S. Pat. No. 5,854,968, and Dietz et al. U.S. Pat. No. 5,863,439 for an illustrative discussion of this separation medium.

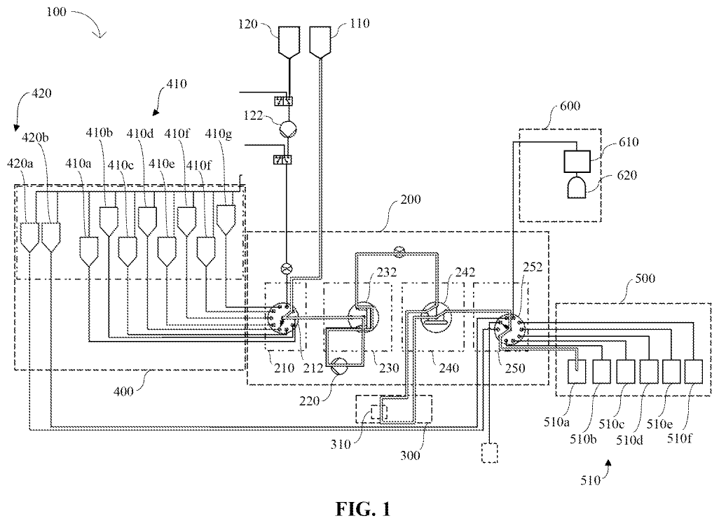

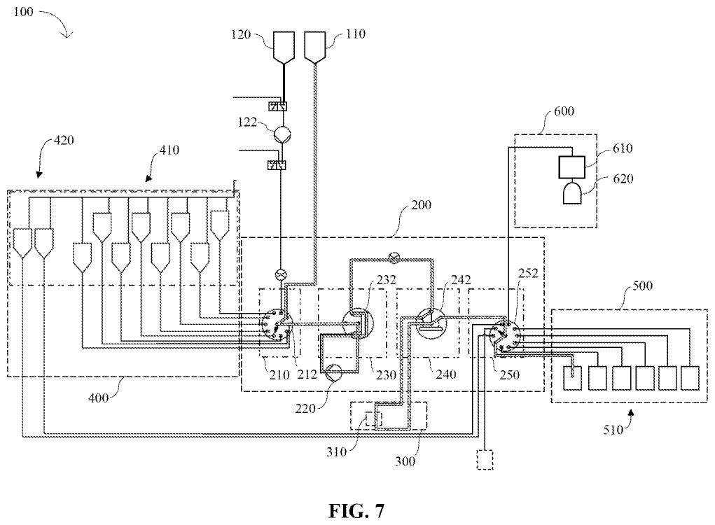

Having discussed the broad aspects of elution and exemplary embodiments, the discussion below and FIGS. 1-7 illustrates preferred embodiments and methods of fractional elution within an elution system 100. The elution system 100 can include one or more inlets or inputs. As seen in FIGS. 1-7, the elution system 100 can include a first inlet 110 for a conditioning fluid and a second inlet 120 for a stripping solution. The first inlet 110 and the second inlet 120 can each further include a pump. For example, the first inlet 110 includes a stripping solution pump 122. Additional inlets to the elution system 100 can be included in a source container 400. These inlets can feed into a fluid movement system 200 and/or a PSC (primary separation cartridge) bay 300. These components can form a fluid flow control system. These components can then feed into a recycling accumulator 500 and/or a product bay 600. The recycling accumulator 500 and/or the product bay 600 can be outlets or outputs of the elution system 100.

The fluid movement system 200 can be in fluid communication with the first inlet 110, the second inlet 120, and/or the source container 400. Thus, the fluid movement system 200 can include one or more components for directing a fluid flowing through the fluid movement system 200, such as an inlet manifold 210 including an inlet valve 212, a pump 220, a pump manifold 230 including a pump valve 232, a PSC manifold 240 including a PSC valve 242, and an outlet manifold 250 including an outlet valve 252. These components of the fluid movement system 200 can control fluid flow and fluid flow direction through the elution system 100.

The PSC bay 300 can include one or more columns 310, wherein the column 310 contains ABEC® resin as described above. The PSC Bay 300 can be in fluid communication with the fluid movement system 200, wherein a fluid flow path can be formed between the PSC manifold 240 and the column 310.

The source container 400 can provide one or more inlets or inputs into the system and can include one or more source locations and/or one or more transfer locations. As shown, the source container 400 includes eight source locations 410a-410h, collectively referred to as the source locations 410.

The source locations 410 can contain a liquid solution of source material, such as a mother radionuclide. The source container 400 further includes two transfer locations 420a-420b, collectively referred to as the transfer locations 420. The transfer locations 420 can be designed to contain the source material solution that has passed through the elution system 100.

It is to be understood that the source container 400 can include more or fewer source locations 410 and/or transfer locations 420, depending on the embodiment. The source container 400 can be in fluid communication with the fluid movement system 200, wherein a fluid path is formed between the source locations 410 and the inlet manifold 210, and another fluid path is formed between the transfer locations 420 and the outlet manifold 250.

The recycling accumulator 500 can include one or more recycling containers for collecting the conditioning fluid, residual source material solution, the stripping solution, or any other fluid passed through the elution system 100. As shown, the recycling accumulator 500 includes six recycling containers 510a-510f, collectively referred to the recycling containers 510. However, the recycling accumulator 500 can include more or fewer recycling containers 510, depending on the embodiment. The recycling accumulator 500 can be in fluid communication with the fluid movement system 200, wherein a fluid path is formed between the outlet manifold 250 and the recycling containers 510.

The product bay 600 can include a guard column 610 and a product container 620 for collecting the product material solution, such as the desired daughter radionuclide solution. In a preferred embodiment, the guard column 610 is a particulate alumina guard column. The product bay 600 can be in fluid communication with the fluid movement system 200, wherein a fluid path is formed between the outlet manifold 250 and the guard column 610. The product bay 600 can then be an outlet or output of the elution system 100.

In an exemplary embodiment of the elution system 100 and method for fractional elution, as shown in FIG. 1, a first step comprises running the conditioning fluid from the first inlet 110 to the fluid movement system 200 and across the column 310 to condition and prepare the column 310 for loading of a source material solution containing a mixture of mother radionuclide and desired daughter radionuclide, and possibly other radionuclides, into the column 310. As described above, the elution system 100 can include one or more valves for controlling the flow through the elution system 100.

Thus, in an exemplary embodiment in a first valve configuration, the inlet valve 212, the pump valve 232, the PSC valve 242, and the outlet valve 252 can be positioned so that the conditioning fluid enters the fluid movement system 200 via the inlet manifold 210, passes through the pump 220, through the pump manifold 230 and the PSC manifold 240, through the column 310 of the PSC bay 300, back through the PSC manifold 240, through the outlet manifold 250, and out to the recycling containers 510 of the recycling accumulator 500. The pump 220 can help provide a desired flow rate through the elution system 100.

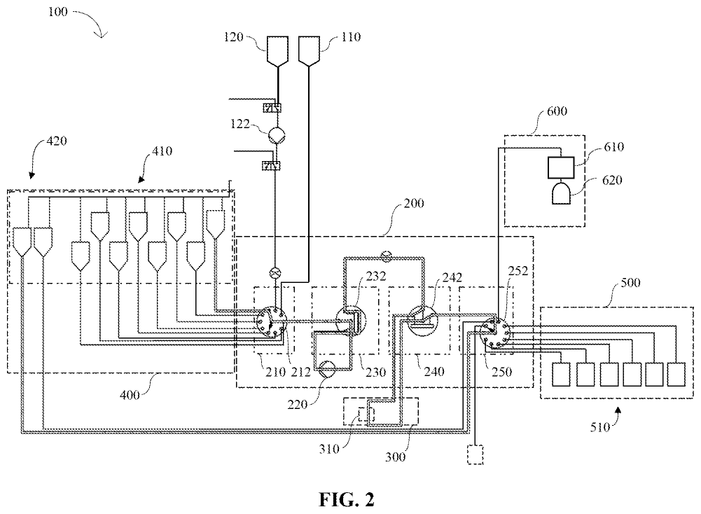

After the column 310 is conditioned, during a second step as shown in FIG. 2, a fractional amount of the source material solution contained in one or more of the source locations 410 is input from the source container 400 and is loaded across the column 310 and collected in the transfer locations 420.

Thus, in an exemplary embodiment in a second valve configuration, the inlet valve 212, the pump valve 232, the PSC valve 242, and the outlet valve 252 can be positioned so that the source material solution enters the fluid movement system 200 via the inlet manifold 210, passes through the pump 220 and is directed through the pump manifold 230 and the PSC manifold 240, travels through the column 310 of the PSC bay 300, passes back through the PSC manifold 240, passes through the outlet manifold 250 and exits the fluid movement system 200 to the transfer locations 420.

The source material solution can be loaded from either top to bottom of the column 310 or from the bottom to the top of the column 310, depending on the orientation of the PSC valve 242. Further, software can be used to track the fractional amount of the source material solution that is eluted, the retained activity of the daughter radionuclide in the source material solution, and the subsequent in-growth. Thus, the software can calculate an estimated source activity. Further, in some exemplary embodiments, the fluid movement system 200 can include a dose meter. Thus, the software can base the estimated source activity on the tracked fractional amount of the source material solution that eluted, the retained activity of the daughter radionuclide in the source material solution, the subsequent in-growth, and the determined dose to estimate the source activity.

As used herein, the term “in growth” is defined as the continuous decay of the parent radionuclide. Thus, even after a daughter radionuclide is eluted off from the parent radionuclide, the parent continues to decay into the daughter radionuclide. The software can be configured to track the concentration of the mother and daughter radionuclides over time and provide an estimated yield from an elution of the source at any time.

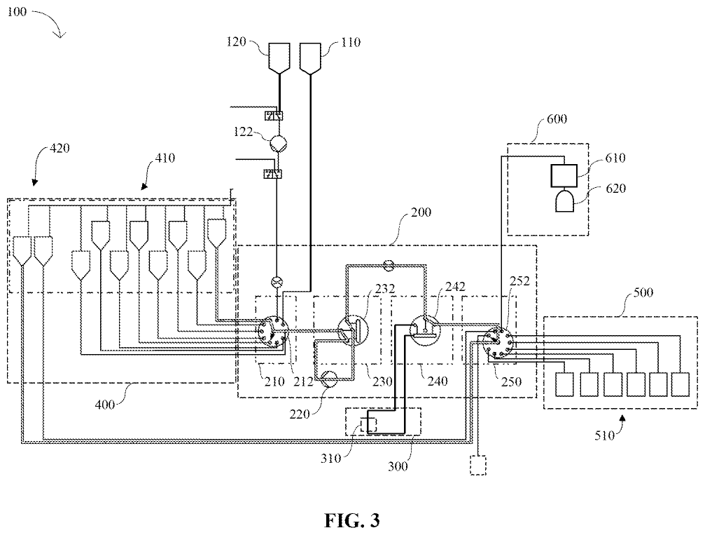

As shown in FIG. 3, during a third step, the source material solution is moved from the one or more transfer locations 420 back to the one or more source locations 410 in the source container. Thus, in an exemplary embodiment in a third valve configuration, the orientation of the pump valve 232 can be adjusted to change the direction of flow through the fluid movement system 200. Accordingly, the third step may be referred to as a source return step or an unloading step because the source material is moved back to the one or more source locations 410.

In some embodiments, the source material is run through the column 310 a second time, either top to bottom or bottom to top, depending on the PSC valve 242 orientation. However, in other embodiments, the PSC valve 242 is positioned so that the column 310 is bypassed. In another exemplary embodiment, the pump 220 can be designed to run in reverse to change the direction of flow through the fluid movement system 200.

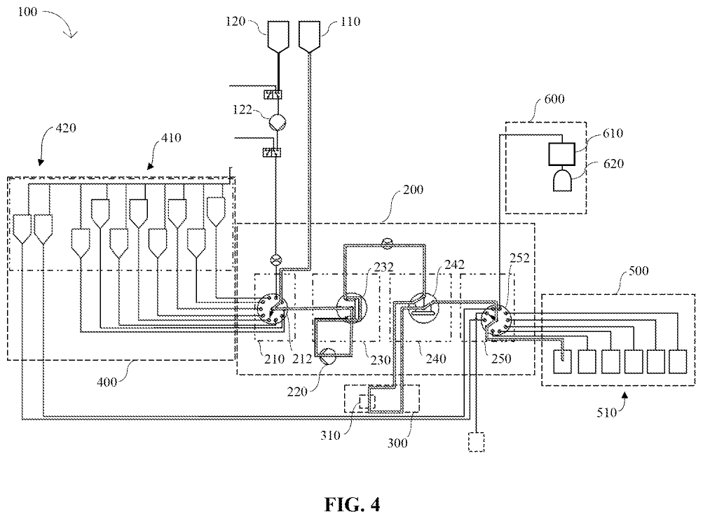

As shown in FIG. 4, during a fourth step, the conditioning fluid is run across the column 310 to wash the residual mother radionuclide out of the column 310. Thus, the conditioning fluid can also be a washing solution. The conditioning fluid can be collected in the recycling containers 510. Thus, similar to the first valve configuration, in an exemplary embodiment in a fourth valve configuration, the inlet valve 212, the pump valve 232, the PSC valve 242, and the outlet valve 252 can be positioned so that the conditioning fluid enters the fluid movement system 200 via the inlet manifold 210, passes through the pump 220, through the pump manifold 230 and the PSC manifold 240, through the column 310 of the PSC bay 300, back through the PSC manifold 240, through the outlet manifold 250, and out to the recycling containers 510 of the recycling accumulator 500.

In a preferred embodiment, the mother radionuclide is Mo99 as Mo₄⁻², and the conditioning fluid is NaOH. Thus, when the column 310 is washed with the conditioning fluid, the residual Mo source material is washed out of the column 310; however, the daughter radionuclide, Tc99m, is not washed away because Tc99m binds to the column 310 when the pH value is high.

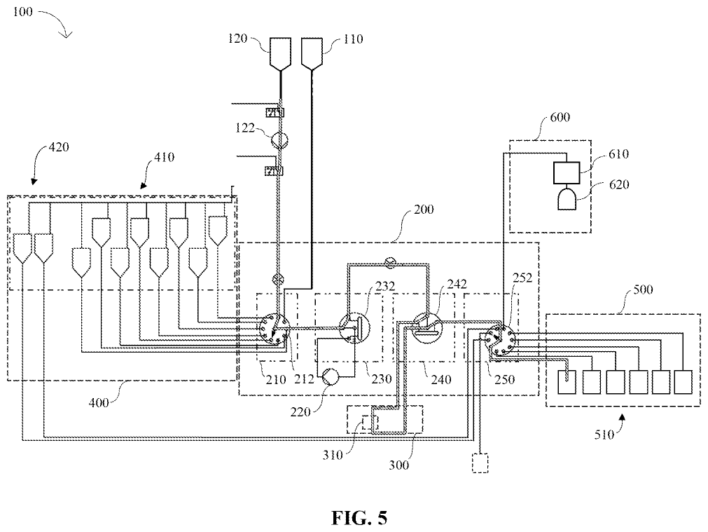

During a fifth step, illustrated in FIG. 5, the stripping solution is introduced to the elution system 100 through the second inlet 120 and run across the column 310 to begin lowering the pH value and to wash away the excess conditioning fluid. The used stripping solution can be collected in the recycling containers 510. Further, in one exemplary embodiment, the flow through the column 310 can be reversed, such that stripping solution flows from the bottom of the column 310 out through the top of the column 310. Accordingly, the flow direction through the column 310 may be based on the direction of the source load.

In a preferred embodiment, the stripping solution is a saline solution. To limit contamination in the elution system 100, the stripping solution pump 122 can be used to push the stripping solution through the system. Thus, the stripping solution does not pass through the pump 220. In an exemplary embodiment in a fifth valve configuration, the inlet valve 212, the pump valve 232, the PSC valve 242, and the outlet valve 252 are positioned so that the stripping solution enters the fluid movement system 200 via the inlet manifold 210, is directed through the pump manifold 230 away from the pump 220, into the PSC manifold 240, through the column 310, back through the PSC manifold 240, through the outlet manifold 250, and out to recycling containers 510 of the recycling accumulator 500.

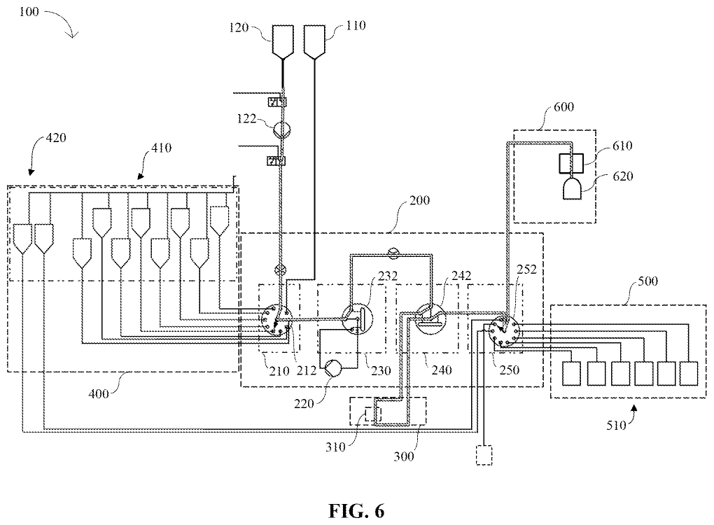

As shown in FIG. 6, after washing, the column 310 can have a low enough pH value to release the daughter radionuclide. Thus, the product (i.e., the daughter radionuclide) can be collected in the product container 620 of the product bay 600.

In an exemplary embodiment in a sixth valve configuration, the inlet valve 212, the pump valve 232, the PSC valve 242, and the outlet valve 252 are positioned so that the stripping solution enters the fluid movement system 200 via the inlet manifold 210, is directed through the pump manifold 230 away from the pump 220, into the PSC manifold 240, through the column 310, back through the PSC manifold 240, through the outlet manifold 250, and out to the product container 620. As discussed above, the product bay 600 can include a guard column 610 upstream of the product container 620. The guard column 610 can help filter out impurities from the product prior to collecting the product in the product container 620.

Further, in another exemplary embodiment, the flow through the column 310 can be reversed, such that stripping solution flows from the bottom of the column 310 out through the top of the column 310. Accordingly, the flow direction through the column 310 may be based on the direction of the source load.

In a seventh step, the column 310 can be prepared for subsequent runs by running the conditioning fluid through the system again. Thus, similar to the first and fourth valve configurations, in a seventh valve configuration, the inlet valve 212, the pump valve 232, the PSC valve 242, and the outlet valve 252 are positioned so that the conditioning fluid enters the fluid movement system 200 via the inlet manifold 210, is directed through the pump manifold 230 and the pump 220, into the PSC manifold 240, through the column 310 of the PSC bay 300, back through the PSC manifold 240, through the outlet manifold 250, and out to the recycling containers 510 of the recycling accumulator 500.

As described above, the pump valve 232 and the PSC valve 242 can be positioned to accommodate several different flow paths. Thus, the pump valve 232 can be a rotary reversing bypass valve. As such, the pump valve 232 can be configured to run forward through the pump 220 on the flow path connected to it, run backward through the pump 220 on the flow path loop, or bypass the pump 220 flow path loop. Further, the PSC valve 242 can be a rotary reversing bypass valve. Thus, the PSC valve 242 can be configured to run top to bottom through the column 310, bottom to top through the column 310, or bypass the column 310.

It is to be understood that between each fluid step described above, that air can be used to clear fluids out of the fluid paths of the elution system 100. It is to be further understood that the elution system 100 can include one or more components typical to elution systems, although not described herein. As such, the foregoing description and the examples are intended as illustrative and are not to be taken as limiting. Still other variations within the spirit and scope of this invention are possible and will readily present themselves to those skilled in the art.

1. A method for eluting a desired activity concentration of radionuclide activity of a desired daughter radionuclide-containing aqueous eluate that comprises the steps of:
contacting separation particles with an aqueous solution that comprises a mixture of a mother radionuclide and a desired daughter radionuclide, and wherein the desired daughter radionuclide has a high affinity for and binds to the separation particles and the mother radionuclide has a low affinity for and does not bind to the separation particles to form a dispersion containing at least water, the separation particles, the desired daughter radionuclide, the separation particles bound to the desired daughter radionuclide, and a unbound mother radionuclide;
maintaining that contact for a time period sufficient for unbound desired daughter radionuclide to bind to the separation particles;
separating the unbound mother radionuclide from the desired daughter radionuclide-bound separation particles using a washing solution;
stripping a first fractional amount of the bound desired daughter radionuclide from the separation particles using a volume of stripping solution to form the aqueous eluate solution having a desired daughter radionuclide activity; and
retaining a second fractional amount of the desired daughter radionuclide in the separation particles.

2. The method according to claim 1, wherein the desired daughter radionuclide is Tc99m present as TcO₄⁻¹ or Re188 present as ReO₄⁻¹.

3. The method according to claim 2, wherein the separation particles comprise particles having a plurality of covalently bonded —X—(CH₂CH₂O)ₙ—CH₂CH₂R groups, wherein X is O, S, NH or N—(CH₂CH₂O)ₘ—R³, where m is a number having an average value of zero to about 225, n is a number having an average value of about 15 to about 225, R³ is hydrogen, C₁-C₂ alkyl, 2-hydroxyethyl or CH₂CH₂R, and R is selected from the group consisting of ⁻OH, C₁-C₁₀ hydrocarbyl ether having a molecular weight up to about one-tenth that of the —(CH₂CH₂O)ₙ-portion, carboxylate, sulfonate, phosphonate and —NR¹R² groups where each of R¹ and R² is independently hydrogen, C₂-C₃ hydroxyalkyl or C₁-C₆ alkyl, or —NR¹R² together form a 5- or 6-membered cyclic amine having zero or one oxygen atom or zero or one additional nitrogen atom in the ring, said separation particles having a percent CH₂O/mm² of particle surface area of greater than about 8,000 and less than about 1,000,000.

4. The method according to claim 2, wherein the mother radionuclide for the desired daughter radionuclide Tc99m is present as Mo₄⁻²,

5. The method according to claim 2, wherein the mother radionuclide for the desired daughter radionuclide Re188 is present as WO₄⁻².

6. The method according to claim 1, wherein the desired daughter radionuclide is Ac225 present as Ac⁺³.

7. The method according to claim 6, wherein the mother radionuclide for the desired daughter radionuclide Ac225 is present as Ra⁺².

8. The method according to claim 6, wherein the Ra⁺² is one or both of Ra225 and Ra226.

9. The method according to claim 6, wherein the separation particles comprise a diglycolamide extractant corresponding in structure to Formula I, below: 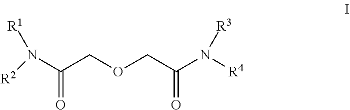
dispersed onto a porous inert resin or silica support, and wherein R¹, R², R³ and R⁴ are the same or different and are hydro or hydrocarbyl groups such that the sum of carbon atoms of R¹+R²+R³+R⁴ is about 14 to about 56.

10. The method according to claim 1, wherein the desired daughter radionuclide is Ga68 present as Ga⁺⁴.

11. The method according to claim 8, wherein the mother radionuclide for the desired daughter radionuclide Ga⁺⁴ is present as Ge⁺⁴.

12. The method according to claim 11, wherein the separation particles comprise a strongly basic anion exchange resin with quaternary ammonium functional groups attached to the styrene divinylbenzene copolymer lattice cross-linked with about 2 to about 12 wt % of divinylbenzene.

13. The method according to claim 1, wherein the desired daughter radionuclide is Bi213 present as Bi⁺³.

14. The method according to claim 13, wherein the mother radionuclide for the desired daughter radionuclide is Ac225 present as Ac⁺³.

15. An elution system, for eluting a desired activity concentration of a radionuclide activity of a desired daughter radionuclide-containing eluate, comprising:
a first inlet for a conditioning fluid;
a second inlet for a stripping fluid;
a fluid movement system in fluid communication with the first inlet and the second inlet;
a primary separation cartridge (PSC) bay in fluid communication with the fluid movement system;
a source container in fluid communication with the fluid movement system; and
a product bay in fluid communication with the fluid movement system.

16. The elution system of claim 15, wherein the fluid movement system comprises:
an inlet manifold comprising an inlet valve configured to direct a direction of fluid flow through the inlet manifold;
a pump manifold downstream and in fluid communication with the inlet manifold, wherein the pump manifold comprises a pump valve configured to direct a direction of fluid flow through the pump manifold;
a pump downstream of the inlet manifold and in fluid communication with the pump manifold;
a PSC manifold downstream and in fluid communication with the pump manifold, wherein the PSC manifold comprising a PSC valve configured to direct a direction of fluid flow through the PSC manifold; and
an outlet manifold downstream and in fluid communication with the PSC manifold, wherein the outlet manifold comprises an outlet valve configured to direct a direction of fluid flow through the outlet manifold.

17. The elution system of claim 15, wherein the PSC bay comprises one or more separation columns.

18. The elution system of claim 15, wherein the source container comprises one or more source locations and one or more transfer locations.

19. The elution system of claim 15, further comprising a recycling accumulator, wherein the recycling accumulator comprises one or more recycling containers designed to collect one or more fluids passed through the elution system.

20. The elution system of claim 15, wherein the product bay comprises a product container.

21. The elution system of claim 15, wherein the product bay comprises a guard column upstream of the product container.

22. The elution system of claim 15, wherein the elution system comprises a stripping solution pump downstream and in fluid communication with the second inlet and upstream of the fluid movement system.

23. In a method for enhancing the radionuclide activity of a desired daughter radionuclide-containing aqueous eluate separated from an aqueous composition containing a mother radionuclide and a daughter radionuclide in which said aqueous composition is 1) contacted with a separation medium in which said desired daughter radionuclide has a high affinity for and binds to said separation medium and said mother radionuclide has a low affinity for and does not bind to said separation medium to form a dispersion containing at least water, separation medium, desired daughter radionuclide, separation medium-bound to said desired daughter radionuclide, and unbound mother radionuclide 2) that contact is maintained for a time period sufficient for unbound desired daughter radionuclide to bind to the separation medium, 3) the unbound mother radionuclide is separated from the desired daughter radionuclide-bound separation medium formed in step 2) using a washing solution, and 4) the bound desired daughter radionuclide is stripped from the separation medium using a volume of stripping solution to form an aqueous eluate;
wherein the improvement comprises stripping a first fractional amount of the bound desired daughter radionuclide from the separation particles using a volume of stripping solution to form the aqueous eluate solution having a desired daughter radionuclide activity, such that a second fractional amount of the desired daughter radionuclide is retained in the separation particles, thereby enhancing the desired daughter radionuclide activity in subsequent elutions than if a fractional amount of the desired daughter radionuclide was not retained in the separation particles.

24. The method according to claim 23, wherein the desired daughter radionuclide is Tc99m present as TcO₄⁻¹ or Re188 present as ReO₄⁻¹.

25. The method according to claim 2, wherein the mother radionuclide for the desired daughter radionuclide Tc99m is present as Mo₄⁻²,

26. The method according to claim 2, wherein the mother radionuclide for the desired daughter radionuclide Re188 is present as WO₄⁻².

27. The method according to claim 1, wherein the desired daughter radionuclide is Ac225 present as Ac⁺³.

28. The method according to claim 6, wherein the mother radionuclide for the desired daughter radionuclide Ac225 is present as Ra⁺².

29. The method according to claim 6, wherein the Ra⁺² is one or both of Ra225 and Ra226.

30. The method according to claim 1, wherein the desired daughter radionuclide is Ga68 present as Ga⁺⁴.

31. The method according to claim 8, wherein the mother radionuclide for the desired daughter radionuclide Ga⁺⁴ is present as Ge⁺⁴.

32. The method according to claim 1, wherein the mother radionuclide for the desired daughter radionuclide Re186 is present at W186.
